(19) United States
(12) Patent Application Publication
(10) Pub. No.: US 2025/0089604 A1
(43) Pub. Date: Mar. 20, 2025

(54) APPARATUS FOR CONTROLLING APPLICATION OF AGRICULTURAL CHEMICALS

(71) Applicant: Loftness Specialized Farm Equipment, Inc., Hector, MN (US)

(72) Inventor: Adam Stephen Goblish, Hector, MN (US)

(21) Appl. No.: 18/370,175

(22) Filed: Sep. 19, 2023

(51) Int. Cl. A01C 17/00; A01C 15/00; A01C 19/02

(52) U.S. Cl. CPC A01C 17/006; A01C 15/006; A01C 17/001; A01C 19/02

(57) ABSTRACT

A variable speed motor driven conveyor of a spreader is controlled, to achieve more precise delivery of agricultural chemicals, using a proportional integral derivative loop when sufficient sensor data is available related to the ground speed of the spreader and the speed of the conveyor, and using stored parameters if sufficient sensor data related to the speed of the conveyor is unavailable.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND

### I. Technical Field

Embodiments relating to equipment and methods used to treat a farm field with fertilizers and other agricultural chemicals are disclosed. More specifically, the embodiments relate to controllers for agricultural spreaders.

### II. Background Discussion

Farmers routinely treat their fields with a variety of agricultural chemicals including fertilizers and nutrients, herbicides, and pesticides. These chemicals are available in both granular and liquid form.

Historically, chemicals in granular form have been dispensed using a spreader pulled by a tractor. Such spreaders typically include a container in the form of a hopper, a flow regulator in the form of a gate at the bottom of the hopper, and a conveyor in the form of an apron, and an applicator. The apron is employed to deliver material to the applicator, for example a spinner assembly or an air boom assembly. Such spreaders may include hydraulic or electric linear actuators to adjust the position of the gate, and a hydraulic or electric motor to rotate the apron.

A spinner assembly will include at least one spinner, i.e., a rotating disk with fins, and a hydraulic or electric motor to rotate the spinner. The spinner assembly may also include multiple spinners driven by the same motor or multiple motors. When multiple spinners are employed, the spinner assembly also includes a diverter or distribution manifold adapted to receive material from the apron, divide the material into portions and deliver a portion of the chemical material received from the end of the apron to each of the spinners. When in use, the hopper is filled with the granular agricultural chemical(s) to be dispensed, the gate is opened allowing chemical(s) to flow onto the apron, the apron carries the chemical(s) to the spinner assembly, and the spinner(s) of the spinner assembly are rotated to dispense the chemical(s) onto the field as a tractor pulls the spreader across the field.

An air boom assembly includes a plurality of pipes in fluid communication with a distribution manifold at one end and nozzles at the other end. At least one motor driven fan delivers air under pressure through each of the pipes. When in use, the hopper is filled with the granular agricultural chemical(s) to be dispensed, the gate is opened allowing chemical(s) to flow onto the apron, the apron carries the chemical(s) to the manifold. The manifold divides the material so that a selected portion of the material is deposited into each of the pipes. The granular material so deposited is entrained in the air flowing through the pipes and carried by such airflow through the pipes and out the nozzles onto the field as a tractor pulls the spreader across the field.

Various factors affect the amount of chemical dispensed and the amount of ground treated with the dispensed chemical using a spreader having either a spinner assembly or an air boom assembly. These factors include the size, texture and other physical attributes of the chemicals being dispensed. These factors also include the speed of the tractor, the position of the gate relative to the fully opened and fully closed positions, the speed at with the apron is rotating, and the speed at with the spinners/fan(s) are rotating.

Historically, chemicals in liquid form have also been dispensed using a spreader pulled by a tractor. Such spreaders typically include an applicator in the form of a liquid boom assembly including a plurality of pipes, each extending from a manifold to a separate nozzle. Such spreaders also include a container in the form of a tank, a flow regulator in the form of a first valve at the bottom of the tank, and a conveyor comprising a pump driven by a hydraulic or electric motor. More specifically, the conveyor includes a pump having and input port connected by a first hose to the first valve and an output port connected by a second hose either directly to an input port of a manifold or to a second valve plumbed between the output port of the pump and the input port of the manifold. The manifold has a plurality of output ports, each in fluid communication with a separate pipe and nozzle of the boom. The valve(s) and motor are operated to cause the pump to deliver the liquid material to the manifold which meters the material so that a selected portion of the material is deposited into each of the pipes and then dispensed via each of the nozzles onto the field as a tractor pulls the spreader across the field.

Proper treatment of a farm field with such chemical is essential to maximizing crop yield. Application of an insufficient quantity reduces yield. Application of too much can damage the crop. Also, agricultural chemicals tend to be a large expense for the farmer. The farmer wants to ensure even application without waste. Also, some modern tractors are equipped with GPS and field mapping technology. Such a tractor towing a spreader could change the application rate on the fly based on the varying needs of the soil at different portions of the field.

Several manufacturers today use proportional integral derivative (PID) computations, referred to as PID loops, performed by a controller to control chemical application rates. Problems arise when a controller relies exclusively on such a PID loops. For example, if either the apron or spinner feedback loops fail or go to zero, the PID loop continuously increases driving rate to attempt to control the speed of the apron or pump. As such, these PID loops offer no control over the speed when the power for the driving motor of the apron or pump is off, e.g., the hydraulics are not on in the case of hydraulic drive motors, or the power is not on in the case of electric drive motors. In as little as 20 to 30 seconds, the valve controlling the hydraulic motor driving the apron or pump will be fully open. When power is restored to the motor, the motor will take off and run at full speed since the driving frequency will be 100%. Similar problems exist when an electric motor is used.

A real need, therefore, still exists for a simple and effective way, to control the motor in a manner that overcomes this problem.

### SUMMARY

Delivery accuracy and reduction of chemical waste are both achieved, when operating a spreader having either an apron driven by a hydraulic or electric variable speed motor, or a pump driven by a hydraulic or electric variable speed motor, by utilizing a controller that both employs a PID loop and provides fault protection in the event feedback signals are not being received as anticipated by the controller. In normal operation, the controller uses first signals indicative of the ground speed of the spreader and second signals indicative of the rotational speed of the apron or pump of the conveyor to constantly adjust the speed of the variable speed motor powering the apron or pump to optimize delivery of the chemical being applied to a field. However, whenever the feedback loop is lost, the controller is still able to adequately control the variable speed motor by interpolating from stored values in a table to determine the correct output and the motor will spin at a rate that is much closer to the desired rate until feedback is restored so the PID loop is able to reassume control and reliably modulate to the rate. Further, when power is restored, the variable speed motor will not take off and run at full speed. More specifically, the controller functions with only a ground speed input at bare minimum to provide satisfactory rate control and uses a feedback loop allowing the controller to lock in on a rate better than just using stored values and interpolation alone. The controller can also control multiple channels at different rates when a plurality of aprons/pumps and variable speed motors are employed. Speed control can be tied to ground speed as is the case with the apron variable speed motor or pump variable speed motor, or another variables or parameters. In the case of spinner speed, a table determines the target spinner speed based on spread width.

### BRIEF DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts:

FIG. 1 is rear perspective view of a fertilizer spreader.

FIG. 2 shows the delivery mechanism of the spreader of FIG. 2 in greater detail.

FIG. 3 is a schematic diagram of the control system of the fertilizer spreader of FIGS. 1 and 2.

FIG. 4 is a flowchart illustrating operation of the control system of FIG. 3.

### DETAILED DESCRIPTION

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

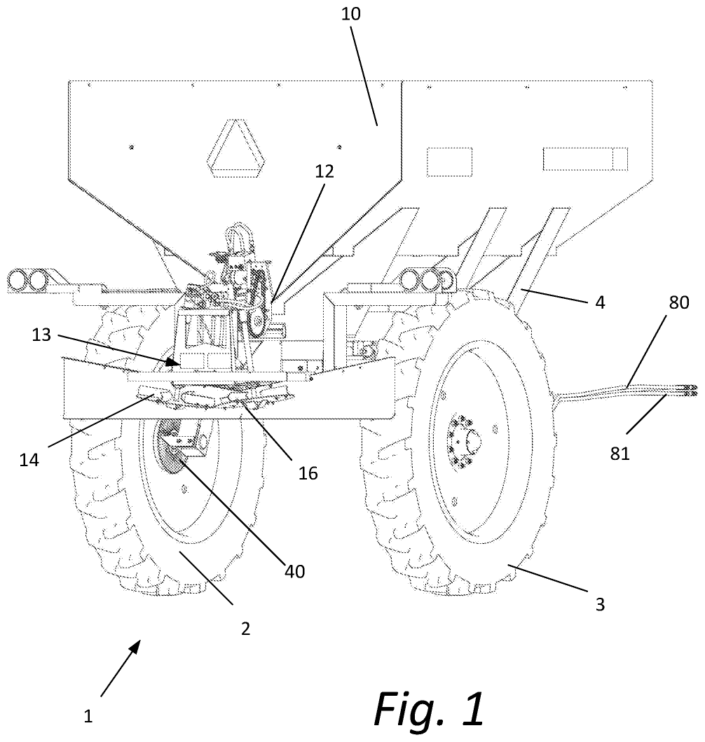

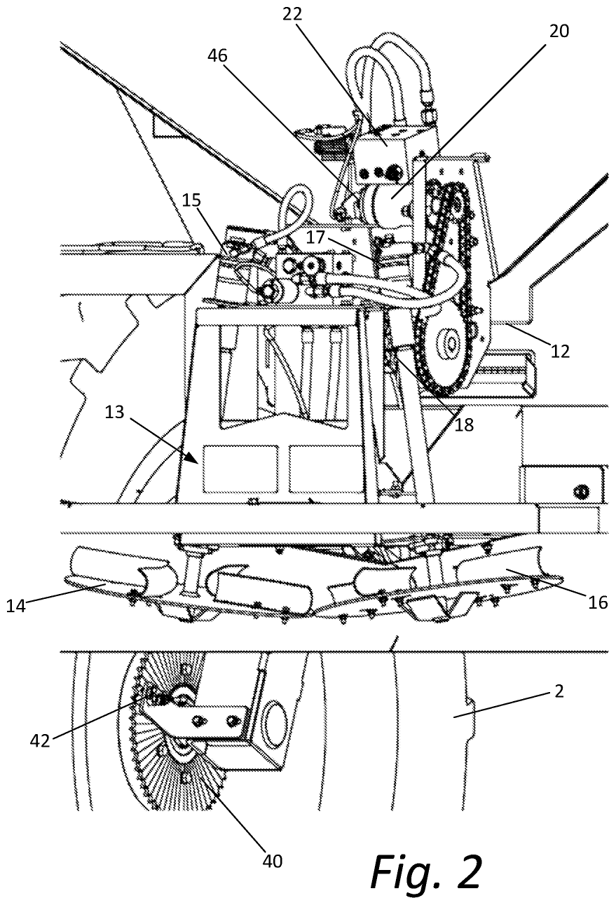

FIGS. 1 and 2 show a spreader 1 adapted to be towed by a tractor (not show). Spreader 1 is supported by a pair of wheels 2 and 3 and a frame 4. Mounted above the frame is a container in the form of a hopper 10. Hopper 10 is sized to carry a load of fertilizer (or other agricultural chemicals) to be spread across a farm field as spreader 1 is towed by the tractor. Located at the bottom of the hopper is a flow regulator in the form of a metering gate 12. The position of the metering gate 12 can be adjusted manually or via a motor such a hydraulic or electric linear actuator.

The spreader shown in FIGS. 1 and 2 includes an applicator in the form of a spinner assembly. The spinner assembly shown includes a distribution manifold 13, and left and right spinners 14 and 16. An apron 18 is positioned to carry agricultural chemicals existing the hopper 10 through the metering gate 12 to the distribution manifold 17 which separates the material so that a separate portions of the material are deposited onto each of the spinners 14 and 16. The apron 18 is driven by an electric or hydraulic variable speed drive motor 20. While the spinners 14 and 16 can each be individually and separately driven by its own hydraulic variable speed motor 15 and 17, spinners can also be driven by a single hydraulic or electric motor connected to the spinners by means of a mechanical power transmission device such as a gearbox, belt, chain, or combination thereto.

The spreader illustrated uses a variable speed hydraulic drive motor 20 and therefore includes a hydraulic manifold 22 (i.e., a series of fittings and controlled valves) adapted to control the flow of hydraulic fluid to the hydraulic motor(s) though hoses hydraulically coupling the motor(s) to the hydraulic manifold 22. In most embodiments, the hydraulic fluid will be carried to the hydraulic manifold 22 by a pump located in the tractor via lines 80 and 81. In other embodiments, a hydraulic pump may be located on the spreader 1 and powered by a power takeoff coupled to the tractor. One or more electric motors may also be used in lieu of any (or all) of the hydraulic motors.

The type of spreader employed may vary from what is shown in FIGS. 1 and 2. For example, rather than using spinners 14 and 16 to apply the granular material, an applicator comprising an air boom assembly may be employed. As is well-known in the art, such an air boom assembly includes a plurality of pipes in fluid communication with a manifold. A motor driven fan delivers air under pressure to each of the pipes. When an air boom is used, the hopper 10 is filled with the granular agricultural chemical(s) to be dispensed, the gate 12 is opened allowing chemical(s) to flow onto the apron 18, the apron 18 carries the chemical(s) to the distribution manifold. The distribution manifold divides the material so that a selected portion of the material is deposited into each of the pipes. The granular material so deposited is entrained in the air flowing through the pipes and carried by such airflow through the pipes and out nozzles at the end of each pipe onto the field as a tractor pulls the spreader across the field.

The spreader could also be adapted to spread liquid materials onto the field. Such a liquid spreader includes an applicator comprising a boom including a plurality of pipes, each terminating in separate nozzle. Such a liquid spreader also includes a container in the form of a tank, a flow regulator in the form of a first valve at the bottom of the tank, and a conveyor comprising a pump driven by a variable speed hydraulic or electric motor. More specifically, the conveyor comprises a pump having an input port connected by a first hose to the first valve and an output port connected by a second hose either directly to an input port of a distribution manifold or to a second valve plumbed between the output port of the pump and the input port of the distribution manifold. The distribution manifold has a plurality of output ports, each in fluid communication with a separate pipe and nozzle of the boom. The valve(s) and variable speed motor are operated to cause the pump to deliver the liquid material to the distribution manifold which divides the material so that a selected portion of the material is deposited into and flows through each of the pipes and is then dispensed via each of the nozzles onto the field as a tractor pulls the spreader across the field.

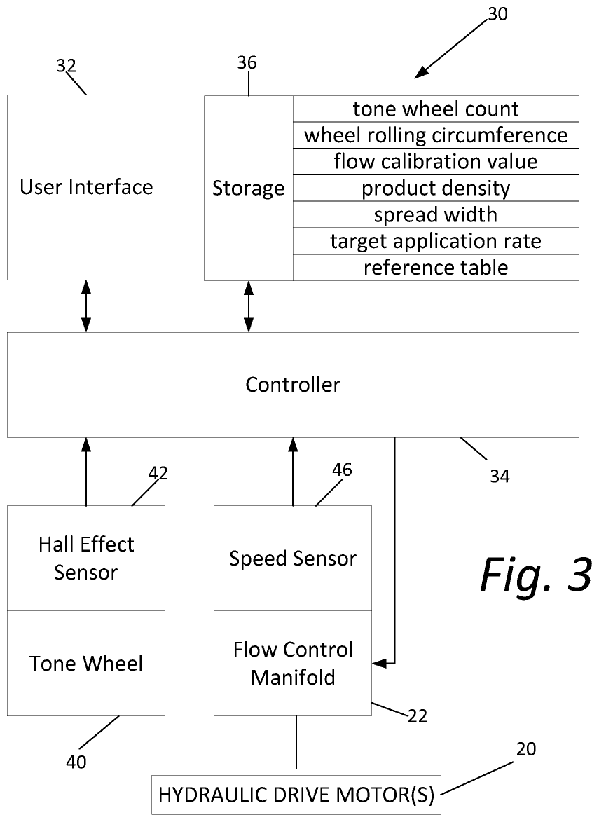

FIG. 3 illustrates one embodiment of the control system 30. Control system 30 comprises a user interface 32 and a controller 34. The user interface may consist of a touch screen device coupled to the controller. Controller 34 may be of any acceptable well-known design including a processor, clock, memory, input/output (I/O) ports, and either includes or is coupled to a storage device 36 such as an internal or external solid-state drive (SSD).

In its simplest form, control system 30 includes two sensing devices that send signals to controller 34 for processing. The first sensing device is a speed sensor of any suitable type for sensing the speed at which the spreader is moving across a field. The first sensing device shown comprises a tone wheel 40 coupled to wheel 2 and a wheel speed sensor 42, e.g., a Hall Effect Sensor. The wheel speed sensor 42 is thereby adapted to sense the rotational speed of the tone wheel 40, and thus wheel 2, and sends signals indicative thereof to the controller 34. The first sensing device could be any other sensor adapted to send signals the controller 34 can use to determine the speed at which the spreader is moving across the field. Other examples include, but are not limited to, contact sensors, magnet sensors, encoders, ground speed radar sensors, or GPS modules.

The second sensing device is a sensor 46 employed to measure the speed of the apron 18. In other embodiments, each of wheels 2 and 4, the apron 18, and each spinner 14 and 16 may be equipped with a separate speed sensor coupled to the controller 34. In the case of a liquid spreader, a sensor adapted to either send signals indicative of the rotational speed of the pump or of the flow exiting the pump may be employed.

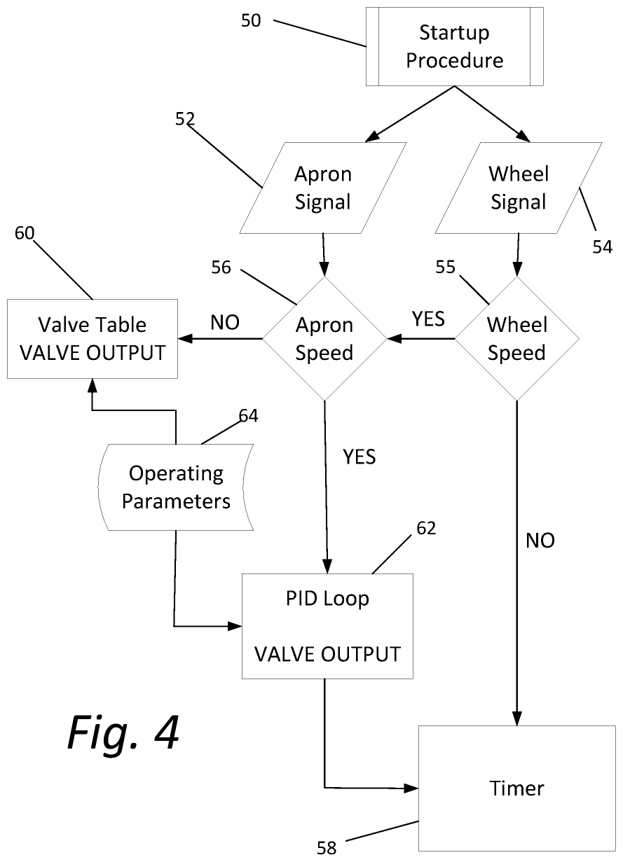

In the example shown in the drawings, controller 34 processes signals received from the sensors 42 and 46, in accordance with a program (see, e.g., FIG. 4), based on inputs received from the user interface 32 and values associated with parameters stored on the storage device 36. Controller 34 also sends control signals to the actuators (e.g., solenoids) of the valves of the flow control manifold 22 to thereby control the speed of at least hydraulic motor 20, and the other hydraulic motors employed in other embodiments. When an electric motor is used instead of a hydraulic motor, controller 34 sends control signals directly to the motor. Such an electric motor will preferably be a servo motor such that its encoder (i.e., sensor) sends speed and position feedback signals to the controller, or stepper motor.

In the case of a spreader utilizing an air boom instead of spinners, the controller operates in the same manner described in the preceding paragraph but could also be used to control the speed of the fan. In the case of a liquid spreader, controller 34 processes signals received from the first sensing device (e.g., a sensor such as sensors 42) and a second sensing devices (e.g., a sensor adapted to sense either the speed of the pump or flow from the pump) in accordance with a program (see, e.g., FIG. 4), based on inputs received from the user interface 32 and values associated with parameters stored on the storage device 36. When the variable speed motor driving the pump is a hydraulic motor, controller 34 also sends control signals to the actuators (e.g., solenoids) of the valves of the flow control manifold 22 to thereby control the speed of the hydraulic motor powering the pump. When an electric motor is used instead of a hydraulic motor, controller 34 sends control signals directly to the motor. Such an electric motor will preferably be a servo motor such that its encoder sends speed and position feedback signals to the controller, or stepper motor.

In the example illustrated in the drawings, during normal operation in which the feedback loop is operational and signals are being received from sensor 46, the controller 34 employs a PID loop to modulate the speed at which variable speed motor 20 moves apron 18 to precisely deliver material to distribution manifold 13 and the spinners 14/16 so the material is ultimately applied at the correct rate to the field. A unique feature of the controller 34 of the present invention is employed when the feedback loop is lost. When this occurs controller 34 defaults to interpolating stored values in a table located on the storage device 36 to approximate the correct output to the variable speed apron motor 20. As such, when the feedback loop is not functioning the variable speed apron motor 20 will spin at a rate that is much closer to the desired rate than a PID loop that eventually drives to minimum or maximum flow. As soon as the feedback loop returns to operation, the PID loop takes over and modulates to the correct rate. This unique feature allows controller 34 to not only function with only a ground speed input from the wheel speed sensor 42 to provide satisfactory rate control, but also to utilize a feedback loop allowing the controller 34 to lock in on a better, more refined rate than just using stored values and interpolation alone.

When an air boom assembly is employed rather than a spinner assembly, the control system 30 works essentially as described in the preceding paragraph. During normal operation in which the feedback loop is operational and signals are being received from sensor 46, the controller 34 employs a PID loop to modulate the speed at which motor 20 moves apron 18 to precisely deliver material to the distribution manifold and air boom so the material is applied at the correct rate to the field. If the feedback loop is lost, controller 34 defaults to interpolating stored values in a table located on the storage device 36 to approximate the correct output to the variable speed apron motor 20. As such, when the feedback loop is not functioning the variable speed apron motor 20 will spin at a rate that is much closer to the desired rate. As soon as the feedback loop returns to operation, the PID loop takes over and modulates to the correct rate. Again, this unique feature allows controller 34 to not only function with only a ground speed input from the wheel speed sensor 42 (or any other ground speed sensor) to provide satisfactory rate control, but also to utilize a feedback loop allowing the controller 34 to lock in on a better, more refined rate than just using stored values and interpolation alone.

When the control system of the present invention is employed with a liquid spreader rather than a granular material spreader, the control system 30 again works essentially as described above. During normal operation in which the feedback loop is operational and signals are being received from the pump speed or flow sensor, the controller 34 employs a PID loop to modulate the speed at which the variable speed motor spins the pump to precisely deliver material to the distribution manifold, boom, and nozzles so the material is applied at the correct rate to the field. If the feedback loop is lost, controller 34 defaults to interpolating stored values in a table located on the storage device 36 to approximate the correct output to the variable speed pump motor. As such, when the feedback loop is not functioning the variable speed pump motor will spin at a rate that is much closer to the desired rate. As soon as the feedback loop returns to operation, the PID loop takes over and modulates to the correct rate. Again, this unique feature allows controller 34 to not only function with only a ground speed input from the wheel speed sensor 42 (or any other ground speed sensor) to provide satisfactory rate control, but also to utilize a feedback loop allowing the controller 34 to lock in on a better, more refined rate than just using stored values and interpolation alone.

In other embodiments other controllable devices may be employed. These, for example, may include (i) additional variable speed motors driving aprons, spinners, fans, or pumps; (ii) linear actuators used to position gates to regulating flow; or (iii) solenoids used to control the position of valves to control flow to and from a pump or variable speed hydraulic motor. In such embodiments, the controller 34 can control multiple channels at different rates. If, for example, sensors are provided to send signals to the controller 34 indicative of the rotational speed of the spinners 14 and 16, similar PID loops may be employed to modulate the speed at which motors 15 and 17 rotate the spinners 14 and 16. In most cases, however, a table determines the target spinner speed based on spread width. Similarly, the ability of controller 34 to control multiple channels allows controller 34 to control the speed of the fan of a spreader equipped with an air boom or the valves of a liquid spreader.

As illustrated in FIG. 4, operation of the spreader involves startup procedure 50. The startup procedure 50 includes connecting the spreader 1 to a tractor's hydraulic system, electrical system, and/or power takeoff. Startup procedure 50 also includes booting up the controller and using the user interface 32 to read out the parameters stored on the storage device 36 and make any adjustments to those parameters. In the example illustrated in the drawings, such parameters include a tone wheel count, a wheel rolling circumference of the wheels 2 and 3, a flow calibration value, the density of the chemical to be applied, the desired spread width of the chemical to be applied by the spreader 1, and a target application rate. The parameters will change depending on the type of spreader and the type of sensors used. For example, the density of the chemical to be applied will be expressed as pounds per cubic foot and the application rate as pounds per acre in the case of the spreader illustrated. A similar parameter may be expressed in gallons per acre in the case of liquid spreaders. Likewise, tone wheel count and wheel rolling circumference may be replaced by other parameters when a different type of sensor is used to determine ground speed. Various reference tables related to the attributes of the spreader and chemical are typically preloaded and saved in the storage device 36. These too can be checked and modified using the user interface 32.

Following the start-up procedure, or as a final step of the startup procedure, the controller checks at step 52 for signals from the apron sensor 46 and at step 54 for signals from the wheel speed sensor 42. In operation, the controller constantly calculates the wheel speed (i.e., ground speed) at step 55 and the apron speed at step 56. If wheel 2 is not turning, the controller shuts down the hydraulic drive motor 20 and periodically performs timing checks at step 58 checking again to determine if the wheel 2 is turning. In other embodiments using another type of sensor to determine ground speed, the controller constantly calculates ground speed and shuts down delivery of the material when the spreader is not moving and periodically performs timing checks to determine if the spreader is again moving.

When wheel 2 is turning (i.e., the spreader is moving), controller 34 calculates the speed at which the spreader 1 is traveling and checks to see if hydraulic drive motor 20 is moving the apron 18 and the speed at which the hydraulic drive motor 20 is moving the apron 18. Controller 34 then employs a PID loop at step 62 constantly adjusting the speed of the hydraulic drive motor 20 (and thus the speed of the apron) to ensure accurate and controlled delivery of the fertilizer or other agricultural chemical onto the field. This is true whether a spinner assembly of an air boom assembly is employed. When the spreader is a liquid spreader, controller 34 calculates the speed at which the spreader 1 is traveling and checks to see if hydraulic drive motor rotating the pump and the speed at which the hydraulic drive motor is moving the pump. Controller 34 then employs a PID loop at step 62 constantly adjusting the speed of the hydraulic drive motor (and thus the speed of the pump) to ensure accurate and controlled delivery of the fertilizer or other agricultural chemical onto the field.

In the event the apron speed is not able to be determined because the controller 34 is not receiving reliable signals from the apron sensor 46, at step 60 controller 34 checks a reference table and other parameters stored in the storage device 36 and the sensed speed of wheel 2 based on signals from the wheel speed sensor 42, to control the apron 18 and its delivery of material to the spinners 14 and 16 and ultimately onto the farm field. Simultaneously, the timer step 58 is run, periodically checking to see if reliable signals indicative of the speed of the wheel 2 and the apron 18 are being received. As soon as such signals are being received, the program reverts to step 62 such that the PID loop resumes control. As indicated in FIG. 4, the stored operating parameters are checked at step 64 whether the controller 34 is employing the PID loop at step 62 or the default valve output at step 60. The system operates in virtually the same way with a liquid spreader except that at step 60 controller 34 checks a reference table and other parameters stored in the storage device 36 and the sensed speed of wheel 2 based on signals from the wheel speed sensor 42, to control the pump and its delivery of material to the distribution manifold, tubes, and nozzles and ultimately onto the farm field. Simultaneously, the timer step 58 is run, periodically checking to see if reliable signals indicative of the speed of wheel 2 and the pump are being received. As soon as such signals are being received, the program reverts to step 62 such that the PID loop resumes control.

Various additional advantages of the present invention should be apparent to one of ordinary skill in the art from the foregoing detailed description and the accompanying drawings. This disclosure is therefore not intended to be limiting.

1. A spreader comprising a container, a flow regulator, a conveyor rotated by a first variable speed motor and adapted to and carry material exiting the container through the flow regulator toward an applicator, a first sensor adapted to generate signals indicative of the ground speed of the spreader, a second sensor adapted to generate signals indicative of the speed at which the conveyer is rotating, and a controller adapted to control the speed at which the conveyer is rotating by (a) employing a proportional integral derivative loop when the controller is receiving signals from the first sensor and the second sensor, and (b) employing a set of stored parameters when the controller is not receiving signals from the second sensor.

2. The spreader of claim 1 wherein the container is selected from a group consisting of a hopper and a tank.

3. The spreader of claim 1 wherein the flow regulator is selected from a group consisting of a gate and a valve.

4. The spreader of claim 1 wherein the conveyor comprises an apron driven by the first variable speed motor.

5. The spreader of claim 1 wherein the conveyor comprises a pump driven by the first variable speed motor.

6. The spreader of claim 1 wherein the applicator is selected from a group consisting of a spinner assembly, an air boom assembly, and a liquid boom assembly.

7. The spreader assembly of claim 1 further comprising a distribution manifold which is adapted to receive material from the conveyor, separate the material into portions, and deliver the portions to the applicator.

8. The spreader of claim 1 wherein the first variable speed motor is selected from a group comprising a hydraulic motor and an electric motor.

9. A spreader comprising a frame supported by at least two wheels, a container, a flow regulator, a conveyor rotated by a first variable speed motor and adapted to and carry material exiting the container through the flow regulator to a manifold adapted to receive material from the conveyor, separate the material into portions and deliver the portions to an applicator, a first sensor adapted to generate signals indicative of the speed of rotation of at least one of said two wheels, a second sensor adapted to generate signals indicative of the speed at which the conveyer is rotating, and a controller adapted to control the speed at which the conveyer is rotating by (a) employing a proportional integral derivative loop when the controller is receiving signals from the first sensor and the second sensor, and (b) employing a set of stored parameters when the controller is not receiving signals from the second sensor.

10. The spreader of claim 9 wherein the first sensor cooperates with a tone wheel.

11. The spreader of claim 10 wherein the first sensor is a Hall Effect sensor.

12. The spreader of claim 9 wherein said first variable speed motor is a hydraulic motor and the spreader further comprises a flow control manifold coupled to the hydraulic motor.

13. The spreader of claim 12 wherein the flow control manifold comprises at least one valve and at least one solenoid adapted to control the position of said at least one valve based on control signals received from the controller.

14. The spreader of claim 9 wherein said first variable speed motor is an electric motor.

15. The spreader of claim 14 wherein the electric motor is a stepper motor.

16. The spreader of claim 14 wherein the electric motor is a servo motor.

17. The spreader of claim 9 wherein the controller comprises a processor, clock, memory, user interface, storage device, and at least one input/output (I/O) port.

18. The spreader of claim 9 wherein the controller is adapted to store and access parameters including a rolling wheel circumference, a tone wheel count, a flow calibration value, a product density, a spread width, and a target application rate.

19. A method of controlling delivery of an agricultural chemical to a farm field comprising:
a. providing a spreader comprising a container, a flow regulator, a conveyor rotated by a first variable speed motor and adapted to and carry material exiting the container through the flow regulator toward an applicator, a first sensor adapted to generate first signals indicative of the ground speed of the spreader, a second sensor adapted to generate second signals indicative of the speed at which the conveyer is rotating, and a controller adapted to control the speed at which the rotating conveyer is rotating;
b. placing a supply of the agricultural chemical in the container and towing the spreader across a farm field while using the controller to (i) constantly adjust the speed at which the first variable speed motor is operating using a proportional integral derivative loop when the controller is receiving the first and second signals, and (ii) control the speed at which the first variable speed motor is operating using a set of stored parameters and said first signals if the controller not receiving the second signals.

20. The method of claim 19 including the further step of adjusting at least one parameter of the set of stored parameters, and wherein the set of stored parameters further comprise at least one of the following parameters: a tone wheel count, a wheel rolling circumference, a flow calibration value, the density of the chemical to be applied, the desired spread width of the chemical to be applied, and a target application rate.
